(19) United States
(12) Patent Application Publication
(10) Pub. No.: US 2017/0197510 A1
(43) Pub. Date: Jul. 13, 2017

(54) Housing For at Least One Object Detection Device, Primary Unit and Payment Slab Assembly

(71) Applicant: BOMBARDIER PRIMOVE GMBH, Berlin (DE)

(72) Inventors: Éanna CURRAN, Darmstadt (DE); Sergio PEREZ, Alsbach-Hahnlein (DE); Oliver VIETZKE, Berlin (DE); Guntram PLETZ, Trippstadt (DE)

(21) Appl. No.: 15/312,826

(22) PCT Filed: Mar. 30, 2015
(86) PCT No.: PCT/EP2015/056844

§ 371 Date: Nov. 21, 2016

(30) Foreign Application Priority Data
May 20, 2014 (GB) 1408932.0

(51) Int. Cl. B60L 11/18; G01V 3/10; H02J 50/60; H02J 50/12; H01F 38/14

(52) U.S. Cl. CPC B60L 11/182; B60L 11/1824; H02J 50/12; H01F 38/14; H02J 50/60; G01V 3/10

(57) ABSTRACT

Provided herein is a housing for at least one object detection device of a system for inductive power transfer to a vehicle. The housing includes at least a top element and at least one bottom element. The top and the bottom element are made of a non-metallic material, and at least a part of the at least one object detection device is arrangeable in between the bottom and the top element. A primary unit and pavement slab assembly are also provided herein.

The invention relates to a housing for at least one object detection device of a system for inductive power transfer, in particular to a vehicle, a primary unit and a pavement slab assembly.

While travelling on a route vehicles require energy for driving (i.e. propulsion) and for auxiliary equipment which does not produce propulsion of the vehicle. Such auxiliary equipment includes, for example, lighting systems, heating and/or air-conditioning systems, ventilation and passenger information systems. Not only track-bound vehicles (such as trams), but also road automobiles can be operated using electric energy. If continuous electric contact between the travelling vehicle and an electric rail or wire along the route is not desired, electric energy can be either withdrawn from an on-board energy storage or can be received by induction from an arrangement of electric lines of the route.

The transfer of electric energy to the vehicle by induction forms a background of the invention. A route-sided conductor arrangement (primary winding structure) of a primary-sided system of the system for inductive power transfer produces an electromagnetic field. The field is received by a secondary winding structure integrated into a receiving device on board of the vehicle so that the field produces an electric voltage by induction. The transferred energy may be used for propulsion of the vehicle and/or for other purposes such as providing the auxiliary equipment of the vehicle with energy.

A problem of such systems for inductive power transfer is that it is generally not possible to mechanically prevent foreign objects, in particular objects made of metal, from being placed into proximity of the primary unit of an inductive power transfer system. Such foreign objects may e.g. comprise a coin, a can, a key, a tool and other objects. The varying magnetic field generated by the primary unit and a secondary unit may induce currents in the foreign objects made of metal and in other objects or fluids. Such currents may cause power losses and heating of the object. Heating of the foreign objects may be dangerous for e.g. persons trying to touch and remove the foreign object and/or may damage the surface the foreign object is placed on or parts of the primary unit. Also, a heated object can cause fire.

To avoid said effects, it is known to use a foreign object detection system associated with a system for inductive power transfer.

WO 2013/036947 A2 discloses a foreign object debris detection system for a wireless energy transfer system comprising at least one magnetic field sensor and at least one readout circuit to measuring electrical parameters of the at least one magnetic field sensor. The at least one magnetic field sensor is positioned within the magnetic field of the wireless energy transfer system.

GB 1222712.0 (not yet published) discloses a safety system for an inductive power transfer system for transferring power to a vehicle on a surface of a route. The document discloses that a detection winding can be part of a LC oscillating circuit.

GB 1222713.8 (not yet published) discloses a safety system for an inductive power transfer system for transferring power to a vehicle on a surface of a route. The document discloses at least one capacitive sensing system.

US 2008/0054905 A1 discloses metal detectors including a sense coil coupled to an analog to digital converter that produces a numeric representation of an electrical signal associated with the conductive object situated in an active region of a sense coil. The document describes that an electric signal in an alternating current part of a LC oscillating circuit is used to detect a foreign object.

U.S. Pat. No. 5,029,300 A discloses a sensor which comprises an oscillating circuit including an LC resonant circuit, wherein a detection signal is prohibited upon arrival of an external radio wave.

GB 1311289.1 (not yet published) discloses an object detection system for an inductive power transfer system, wherein the object detection system comprises at least one LC oscillating circuit and at least one driving circuit, wherein an input side of the driving circuit is connected to a power supply circuit and an output side of the driving circuit is connected to the at least one LC oscillating circuit, wherein the driving circuit provides an alternating current voltage to the at least one oscillating circuit. The object detection system comprises at least one means for capturing an input power to the driving circuit provided by the power supply circuit, wherein the object detection system comprises at least one detection means for detecting a foreign object depending on the captured input power.

If installed in the pavement of a road, the object detection device can be exposed to heavy loads, e.g. of trucks. Such a mechanical stress can damage the object detection device which, in turn, decreases or even prohibits the object detection.

GB 2505516 A1 discloses a pavement slab assembly for a route for vehicles driving or standing on a surface of the route. The pavement slab assembly consists at least partially of pavement material. Further, the pavement slab assembly comprises a cable bearing element adapted to position and/or to hold a plurality of line sections of one or more electric lines. The cable bearing element is arranged within the pavement slab assembly such that the cable bearing element is enclosed by the pavement material.

US 2013/0169062 A1 discloses a contactless electricity supply device, which contactlessly performs charging of the battery of a vehicle, which provided with: an electricity transmission coil disposed at a road surface; and an electricity reception coil disposed in the vehicle. A foreign object detection coil is provided to the upper surface of the electricity transmission coil, and on the basis of induced voltage arising at the foreign object detection coil during a trial electricity supply, foreign objects between the electricity transmission coil and the electricity reception coil are detected.

US 2014/0183970 A1 discloses a power feeder of a contactless power transmission device which includes a housing base member, a primary coil provided on the housing base member and configured to generate magnetic flux, a cover attached to the housing base member and configured to cover the primary coil, a capacitance sensor including a detection electrode between the primary coil and the cover, and configured to detect foreign matter around the cover based on a change in capacitance detected using the detection electrode, and a high-dielectric member embedded in the cover and having a permittivity higher than that of a material for the cover.

It is an object of the present invention to provide a means for integrating at least one object detection device of a system for inductive power transfer into the pavement of a route, wherein a reliable holding and an enhanced mechanical protection of the object detection device is provided.

Another object of the present invention is to provide a primary unit and a pavement slab assembly for building a route for vehicles comprising an object detection device, wherein the route is robust, durable and installable with low effort and also reduces said negative effects.

It is a basic concept of the invention to arrange the object detection device in between a top element and a bottom element which provide a housing for the object detection device, wherein the housing is integrateable into a primary unit or into the pavement of a route.

The present invention can be applied in particular to the field of energy transfer to any land vehicle, in particular track bound vehicles, such as rail vehicles (e.g. trams), but also to road automobiles, such as individual (private) passenger cars or public transport vehicles (e.g. busses).

A housing for at least one object detection device of a system for inductive power transfer is proposed.

The inductive power transfer system can comprise a primary unit, wherein the primary unit can comprise a primary winding structure to generate an alternating electromagnetic field.

The system for inductive power transfer can e.g. by a system for transferring energy to a vehicle, wherein the vehicle is standing or traveling on a route.

Further, the inductive power transfer system can comprise at least one object detection device. The object detection device can be designed as disclosed in GB 1311289.1. The disclosure of said document, in particular of the embodiments of the object detection device, is hereby incorporated by reference into this disclosure. The object detection device can also be designed as the inductive sensing system disclosed in GB 1222712.0. The disclosure of said document, in particular of the embodiments of the inductive sensing system, is hereby incorporated by reference into this disclosure. The object detection device can also be designed as the capacitive sensing system disclosed in GB 1222713.8. The disclosure of said document, in particular of the embodiments of the capacitive sensing system, is hereby incorporated by reference into this disclosure.

The object detection device can comprise at least one sensing element for detecting an object, in particular a metal object, within a predetermined detection volume. The detection volume can comprise at least a portion of the active area or active volume which is assigned to the primary winding structure. Preferably, the detection volume comprises the total active area or active volume.

The active volume can denote the volume which is filled with at least a portion of the magnetic part of the electromagnetic field generated by the primary winding structure or the power transfer field. The field volume can e.g. denote the volume which is filled with at least 80%, 90% or 95% or even 100% of the electromagnetic field. In particular, the field volume can comprise all field lines of the electromagnetic field or at least a predetermined percentage, e.g. 80%, 90% or 95% of the field lines. In this context, the term comprises means that field lines of the magnetic part of the electromagnetic field which is comprised by the field volume do not extend outside the field volume.

The active area can be provided by an area which encloses or is bordered by outer edges of the field volume within a section through the field volume in a section plane which comprises a surface of the route or an upper outer surface of the primary unit. It is also possible that the primary winding structure is at least partially, preferably fully, more preferably exceedingly, arranged within the active area if the primary winding structure is projected onto the surface of the route along a first direction. The term first direction will be explained later. The active area can also enclose the primary winding structure which is projected onto the surface of the route. The active area can also have a predetermined geometric shape, in particular a rectangular shape with predetermined dimensions. In this case, the active area can have a predetermined width and length. Furthermore, it is possible that a predetermined portion of field lines of (the magnetic part of) the electromagnetic field can extend through the active area, e.g. at least 80%, 90% or 95%.

The at least one object detection device is preferably designed as an inductive detection device which comprises at least one inductive sensing element. The at least one inductive sensing element can e.g. be designed as a detection winding. An electric output signal, e.g. an electric output voltage, of the at least one detection winding can depend on an inductance of the at least one detection winding. An object, in particular a metal object, located in proximity of the at least one detection winding can change the inductance of the at least one detection winding and thus an electric output signal. The change of the output signal and/or the deviation from a reference signal can be used to detect the presence of the object.

According to the invention, the inductive detection device comprises one or more excitation element(s), e.g. excitation winding(s). Alternatively or in addition, the inductive detection device comprises one or more detection element(s), e.g. detection winding(s). An excitation element can generate a detection field. The at least one detection element can be arranged and/or designed such that the detection field is receivable by the at least one detection element. The detection field can be different from the power transfer field used to transfer power inductively.

If a foreign object is arranged within the active volume, the output signal generated by the detection element(s) upon reception of the detection field will be different from an output signal in a state in which no foreign object is arranged in the active volume. The object detection can be performed based on a difference between these different output signals, e.g. based on the difference between the corresponding amplitudes.

The object detection device can comprise more than one sensing element, wherein the sensing elements can be arranged and/or designed such that a robust detection is provided for a desired area. Thus, an area detection can be provided by the object detection device.

The object detection device can further comprise at least one control unit, in particular for evaluating an output signal of the at least one sensing element and/or controlling the object detection device.

The part of portion of the object detection device comprising the at least one sensing element and, if applicable, the at least one excitation element can also be referred to as sensing part, wherein the part of portion of the object detection device comprising the control unit can also be referred to as control part.

The object detection device can comprise a detection plate or can be integrated into a detection plate, wherein the detection plate has a predetermined width, length and height. Preferably, the sensing part of the object detection device can comprise the detection plate or can be integrated into the detection plate. The detection plate can e.g. be designed as conductor board.

The housing comprises at least a top element and at least one bottom element, wherein the top and the bottom element are made of a non-metallic material. Alternatively or in addition, the top and the bottom element can be made of a non-magnetic material.

Moreover, the top and the bottom element can be made of a material which is able to withstand a predetermined (high) tensile and bending stress.

The top element and the bottom element can be mechanically connected, e.g. by at least one connecting element. Said connect element can e.g. be provided by a side wall element of the housing.

At least a part or portion of the object detection device is arrangeable in between the bottom and the top element. It is, for instance, possible that at least one sensing element, preferably all sensing elements, is/are arrangeable in between the bottom and the top element. In other words, the aforementioned sensing part can be arranged in between the bottom and the top element.

In other words, a first inner volume can be provided in between the top and the bottom element, wherein the first inner volume is enclosed at least partially by the top and the bottom element. The housing can also comprise at least one side wall element, wherein the first inner volume can also be enclosed by the at least one side wall element. The at least one part of the object detection device can be arranged within the first inner volume. In this case, the control part can also be arranged within the first volume or outside the first volume.

The proposed housing can also be designed such that a carrying element, e.g. a carrying plate, for the elements, e.g. the sensing elements, which provide at least one part of the object detection device, can be arranged within the first inner volume.

The top element and/or the bottom element can comprise several subelements which are designed and/or arranged such that the desired inner volume is provided.

The proposed housing advantageously allows protecting the object detection device from mechanical stress, e.g. caused by vehicles driving across the object detection device, wherein a disturbance of the alternating electromagnetic generated by the primary winding structure and the object detection device, in particular of an inductive object detection device, is minimized.

Also described is a housing which comprises the at least one part of the object detection device, wherein the at least part is arranged between the top and bottom element.

In another embodiment, the top element is designed as a plate and/or the bottom element is designed as a plate. The plate(s) can have a predetermined width, length and height. The width, length and/or height of the top plate and the bottom plate can be equal or different from one another. If the object detection device comprises a plate, e.g. the aforementioned detection plate, which is to be arranged in between the top and the bottom element, the width and length of the top plate and/or the bottom plate is preferably greater than the width and length of the plate of the object detection device.

By designing the top and/or the bottom element as a plate, a simple manufacturing process is provided while a good mechanical protection is ensured.

In a preferred embodiment, the top element and/or the bottom element is/are made of plastic. In particular, the plastic can be a fiber-reinforced plastic, e.g. glass fiber-reinforced plastic. Such a material advantageously attains high values for the modulus of elasticity, in particular near the corresponding value of concrete, high values for the ultimate compressive strength and high values for tensile strength, e.g. close to the corresponding strength of steel.

This advantageously allows a cheap and simple production of the housing.

In another embodiment, a height of the top element is smaller than a height of the bottom element. The height can correspond to a thickness of the top element or bottom element.

In an alternative embodiment, a height of the top element is equal to a height of the bottom element. This advantageously allows a more economical housing material to be produced with only one element thickness required.

In another embodiment, the housing provides an inner volume for arranging a first part of the object detection device and at least another part of the object detection device. This means that the first part and the other part are arranged within the same volume.

The volume can be the first inner volume which has been described previously. The first part can be the aforementioned sensing part. The at least one other part can be the control part, e.g. a control unit. In this case, the sensing part and control part can be located in the same volume between the top element and bottom element which allows producing a slim plate housing and, in particular, reducing a thickness of the bottom element.

In an alternative embodiment, the housing provides a first inner volume for arranging a first part of the object detection device and at least one other inner volume for arranging at least one other part of the object detection device.

In this case, the sensing part can be arranged in the first inner volume, wherein the control part, in particular a control unit, can be arranged within the other volume. The other volume can be arranged outside the first volume, i.e. spatially separated from the first inner volume. The first and the other volume, however, can be connected by at least one connecting means, e.g. at least one opening and/or connection canal.

This advantageously allows separating different parts of the object detection device while ensuring a good mechanical protection for the different parts.

In another embodiment, the bottom element is arranged between the first and the at least one other inner volume. In particular, the bottom element can provide a part of the enclosure of the first volume as well as a part of the enclosure of the other volume.

Further elements, e.g. wall elements, enclosing the other volume can be attached to the bottom element. In this case, the bottom element can comprise at least one opening for connecting means of the control part and the sensing part. This advantageously provides a compact design of the proposed housing.

Further proposed is a primary unit of a system for inductive power transfer, wherein the primary unit comprises at least one primary winding structure and at least one housing according to one of the previously described embodiments or one of the embodiments described in this invention.

Thus, an object detection device is arrangeable at least partially in between the top element and the bottom element of the housing which is a part of the primary unit.

It is, however, also possible that the primary unit comprises the at least one object detection device, wherein at least one part of the object detection device is arranged between the top and the bottom element.

The primary unit can be designed as a charging pad or integrated into a charging pad, wherein the charging pad can be installed on a surface of a route or integrated into the route. The charging pad can be fully or at least partially integrated into the route.

Thus, a primary unit is proposed, wherein undesired foreign objects located in proximity of the primary winding structure can be detected by the object detection device and a mechanical protection of the at least one part of the object detection device is provided.

Further, the housing also provides a fixation means for the at least one part of the object detection device. It is, for instance, possible to attach the at least one part of the object detection device to the top and/or bottom element, in particular by a mechanical connection. Thus, a constant position and/or orientation of the at least one part of the object detection device can be provided.

In another embodiment, a first inner volume of the housing is arranged above the primary winding structure. It is possible that at least a part of the top element and/or at least a part of the bottom element is arranged above the primary winding structure.

The term “above” relates to a first direction of a reference coordinate system of the primary unit, wherein the first direction is oriented parallel to a main direction of extension of the electromagnetic field generated by the primary winding structure. A second direction of the reference coordinate system can be oriented parallel to a longitudinal axis of the primary winding structure. A third direction of the coordinate system can be oriented orthogonal to the first and second direction. The first direction can also be referred to as vertical direction. The second direction can also be referred to as longitudinal direction. The third direction can also be referred to as lateral direction. In the context of this invention, a length can relate to a dimension measured along the second direction, a width can relate to a dimension measured along the third direction and a height can relate to a dimension measured along the first direction.

Thus, the at least one part of the object detection device can be arranged in a desired position and/or orientation by and/or can be mechanically fixed to the proposed housing above the primary winding structure which allows a reliable detection of foreign objects while the housing also provides a good mechanical protection.

In another embodiment, the top element provides an upper outer surface of the primary unit. The upper outer surface can denote a rolling or standing surface of the primary unit, wherein e.g. at least one wheel of a vehicle can contact the upper outer surface.

In this case, the top element is directly exposed to mechanical stress exerted by vehicles which drive across the primary unit or stand on the primary unit. Further, the forces generated by said vehicles are transmitted into the primary unit or the ground by the top element and, if applicable, by the bottom element.

The object detection device is advantageously arranged close to the upper outer surface which improves a detection sensitivity concerning objects located on the upper outer surface. It is, however, not exposed to said forces directly.

Further, the housing can comprise at least one shielding element, e.g. a shielding element made of aluminium. The shielding element can comprise one or more shielding plate(s). The at least one shielding element can be arranged such that a predetermined part of the object detection system, in particular the control part, is shielded against external electromagnetic interferences, e.g. generated by external components, for example antenna loops. This advantageously ensures a correct operation of the object detection system. This at least one shielding element can be integrated into the housing, e.g. into the top element, the bottom element and/or the at least one side wall element.

Further proposed is a pavement slab assembly for a route for vehicles driving on a surface of the route, in particular for road automobiles.

The pavement slab assembly comprises a housing according to one of the previously described embodiments or one of the embodiments described in this invention.

Further, the pavement slab assembly can comprise a primary winding structure. The first volume of the housing can be arranged above the primary winding structure. The term “above” can relate to the aforementioned coordinate system.

Further, the pavement slab assembly can comprise an object detection device, wherein at least a part of the object detection device can be arranged between the top element and the bottom element of the housing.

The pavement slab assembly advantageously allows assembling a route for vehicles while also providing means for an inductive power transfer to the vehicles.

In another embodiment, the top element and/or the bottom element are made of pavement material. In particular, the top and/or the bottom element can be made of concrete. Thus, the pavement slab assembly provides means for holding and protecting the object detection device. These means can be provided integrally with the pavement slab. It is, for instance, possible that the proposed housing is provided by a part of the pavement slab and not as a separate, e.g. plastic, element.

In another embodiment, the top element provides an upper outer surface of the pavement slab assembly. The upper outer surface can be a part of the driving or standing surface of a route provided by the pavement slab assembly. The upper outer surface can be designed such that it provides suitable conditions for a typical driving surface environment e.g. a predetermined UV-, salt-, oil-resistance and predetermined anti-skid and anti-slip characteristics.

As explained previously, this allows integrating the object detection device close to a surface which improves a detection sensitivity for objects located on said surface while a good mechanical protection of the object detection device is provided.

In another embodiment, the pavement slab assembly further comprises a positioning element, wherein the at least one element of the housing and the positioning element are arranged such that the housing is positioned at a predetermined position within the pavement slab assembly.

The positioning element can e.g. be designed as a non-metallic positioning element.

Further, the positioning element can e.g. be designed as an armoring element. The positioning element can e.g. be designed as an armoring mesh or be a part of an amoring mesh.

The positioning element can be used to provide a predetermined, fixed position of housing, in particular of the top element and/or the bottom element, in particular before and during casting of pavement material. In other words, the positioning element can be used to fix or retain at least one element of the housing in predetermined position with regard to e.g. a casting mould during the casting process.

The positioning element and the at least one element of the housing can be arranged such that the element of the housing is positioned at a predetermined position within the pavement slab assembly.

The positioning element and the at least one element of the housing can be mechanically connected. The positioning element can e.g. be designed and/or arranged such that the at least one element of the housing is disposed or positioned at a desired distance from the upper surface of the route. It is of course possible that the pavement slab assembly comprises a plurality of positioning elements.

It is possible that the positioning element is fully arranged within the pavement slab assembly. Alternatively, in particular if the positioning element is provided by an armoring element, the positioning element can extend out of the pavement slab assembly.

In general, the positioning element can provide a supporting means for the at least one element of the housing.

The pavement slab assembly can comprise one or more additional elements. In particular, the pavement slab assembly can be designed similar to one of the embodiments disclosed in GB 2505516 A1. Thus, said document is hereby incorporated by reference. In particular, the pavement slab assembly can comprise a cable bearing element, at least one shielding element and/or one magnetic core element and/or a detection assembly for detecting a vehicle to be charged. At least one element of the housing can be mechanically connected to one of these elements, in particular to the cable bearing element.

Furthermore, a route for vehicles driving or standing, e.g. parking, on a surface of the route, in particular for road automobiles, is disclosed. The route comprises a plurality of pavement slab assemblies according to one of the previously described embodiments or one of the embodiments described in this invention. The pavement slab assemblies are arranged with respect to another such that a driving or standing surface for vehicles is provided. The term “route” denotes one or more sections of the ground providing a driving surface or standing surface for vehicles. Thus, the term route also comprises the ground of a e.g. parking lot or a garage.

Further disclosed is a method for providing primary unit according to one of the previously described embodiments or one of the embodiments described in this invention, wherein the following steps are performed:
providing a housing according to one of the previously described embodiments or one of the embodiments described in this invention,
providing a primary winding structure,
providing an object detection device and
arranging at least a part of the object detection device between the top element and the bottom element of the housing.

Further disclosed is a method of building a pavement slab assembly according to one of the previously described embodiments or one of the embodiments described in this invention, wherein the following steps are performed:
providing a casting mould,
providing a primary winding structure,
providing a housing according to one of the previously described embodiments or one of the embodiments described in this invention,
arranging the primary winding structure and the housing within the casting mould,
casting pavement material into the casting mould, wherein the primary winding and the housing is at least partially enclosed by the pavement material.

Further, an object detection system can be provided. Further, at least a part of the object detection device can be arranged between the top element and the bottom element.

Furthermore, a method of building a route for vehicles driving or standing on a surface of the route, in particular for road automobiles, is disclosed, wherein the following steps are performed:
providing a plurality pavement slab assemblies according to one of the previously described embodiments or one of the embodiments described in this invention,
installing the pavement slabs assemblies on a prepared base or foundation such that a driving surface for vehicles which are driving on the route is provided.

Examples and preferred embodiments of the invention will describe with reference to the attached figures which show:

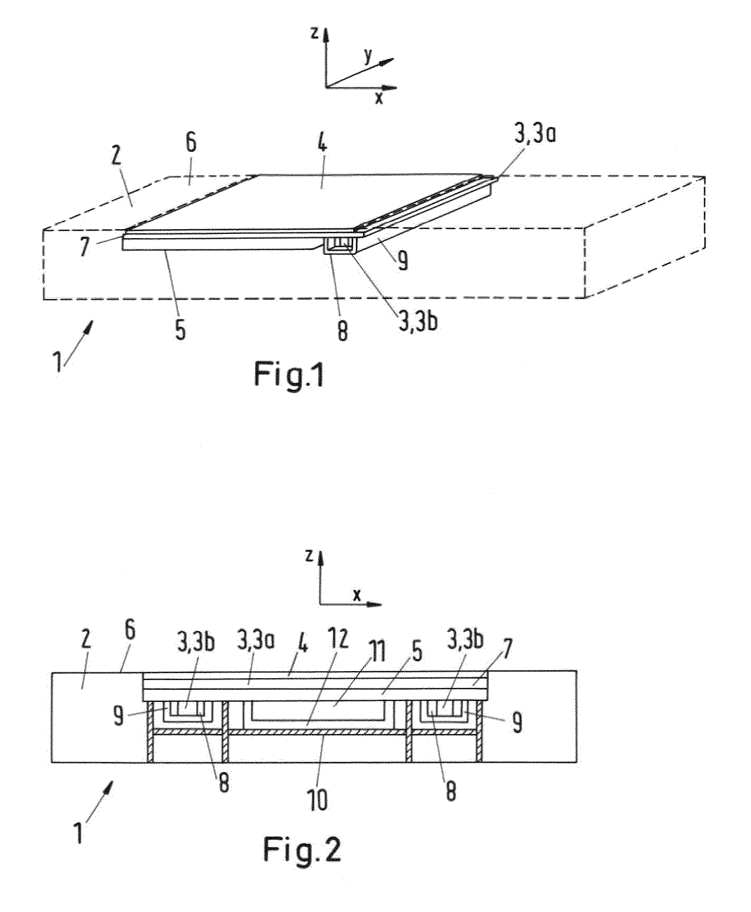

FIG. 1 a perspective view on a pavement slab assembly and

FIG. 2 a cross section through a pavement slab assembly according to another embodiment.

FIG. 1 shows a perspective view on a pavement slab assembly 1. The pavement slab assembly 1 has a rectangular shape. Further, the pavement slab assembly 1 comprises a concrete portion 2, a housing and an object detection device 3. The object detection device 3 comprises a first part 3a, wherein the first part 3a is designed as a detection plate. Sensing elements, in particular inductive sensing elements, e.g. detection windings, which are not shown in FIG. 1 are attached to the detection plate or integrated into the detection plate. Further, the object detection device comprises one or more excitation elements, e.g. excitation winding(s), for generating a detection field. The excitation element(s) can be part of the first part 3a. For example, the excitation element(s) can be attached to or integrated into the detection plate. Further, the object detection device comprises a control part 3b, wherein the control part 3b controls an operation of the excitation element(s) and/or the sensing elements and evaluates output signals provided by the sensing elements.

Further shown is a reference coordinate system. A vertical axis z is oriented orthogonal to an upper surface 6 of the pavement slab assembly. A vertical direction is indicated by an arrowhead of the vertical axis. A longitudinal axis x is oriented parallel to a longitudinal axis of the pavement slab assembly. A longitudinal direction is indicated by an arrowhead of the longitudinal axis. A lateral axis y is oriented orthogonal to the vertical and the longitudinal axis x, z. A lateral direction is indicated by an arrowhead of the lateral axis y.

The housing comprises a top plate 4 and a bottom plate 5, wherein the top plate 4 is arranged above the bottom plate 4 along the vertical axis z. It is shown that a length of the top plate 4 along the longitudinal axis x is greater than a length of the bottom plate 4. A width of the top plate 4 along the lateral axis y is equal to a width of the bottom plate 5. A height of the top plate 4 along the vertical axis z is smaller than a height of the bottom plate 5.

The first part 3a of the object detection device is partially arranged between the top plate 4 and the bottom plate 5. It is shown that at least a portion of the first part 3a is arranged within a first inner volume 7 of the housing, wherein the first inner volume 7 is enclosed by the top plate 4 and the bottom plate 5.

It is shown that a length of the detection plate is greater than a length of the top plate 4 such that the detection plate protrudes out of the first inner volume 7 at a front end of the first inner volume 7 (with respect to the longitudinal direction).

The top plate 4 and the bottom plate 5 are made of plastic. The top plate 4 provides a part of the rolling surface for vehicles.

Further shown is another inner volume 8 of the housing. The control part 3b is arranged within the other inner volume 8. The control part 3b can be connected to the first part 3a by at least one signal connecting means (not shown), e.g. a cable.

The other inner volume 8 is enclosed by wall elements 9 which provide a box-shaped hollow cylinder. The hollow cylinder is arranged adjacent to the bottom plate 5 along the longitudinal direction and below the detection plate with respect to the vertical direction. Also, the detection plate provides a cover or one side wall of the hollow cylinder. If projected into a common plane of projection along the vertical axis, the top plate 4 comprises the bottom plate 5 and the hollow cylinder.

FIG. 2 shows a cross section of a pavement slab assembly 1 according to another embodiment. In contrast to the embodiment shown in FIG. 1, a top plate 4 has the same length and width as a bottom plate 5.

Further shown is that the housing comprises two other inner volumes 8 which are spatially separated, i.e. a second and a third volume. The other inner volumes 8 are separated from the first inner volume 7 by the bottom plate 5. In particular, the first inner volume 7 is arranged above the bottom plate 5, wherein the other inner volumes 8 are arranged below the bottom plate 5. The other inner volumes 8 are enclosed by wall elements 9 which are attached to the bottom plate 9 and provide box-shaped hollow cylinders, respectively.

In each other inner volume 8, a control part 3b of the object detection device 3 is arranged. The control parts 3b can be connected to the first part by at least one signal connecting means (not shown), e.g. a cable which can e.g. extend through an opening, e.g. a through-hole, in the bottom plate 5.

Further shown is a primary winding structure 11 and a cable bearing element 12 which are integrated into the pavement slab assembly 1. The cable bearing element 12 is adapted to position and/or to hold a plurality of line sections of one or more electric lines providing the primary winding structure 11. It is shown that the first inner volume 7 of the housing is arranged above the primary winding structure 11 with respect to the vertical direction z. The other inner volumes 8 are arranged adjacent to, e.g. behind and ahead of, the primary winding structure 11 with respect to the longitudinal direction.

Further shown is an armoring mesh 10 of the pavement slab assembly 1. The bottom plate 5 and the cable bearing element 12 are attached to the armoring mesh 10. Thus, the armoring mesh is used to position the bottom plate 5 (and thus also the side wall elements 9 and the top element 4 which can be mechanically connected to the bottom plate 5) and the cable bearing element 12 at a desired position within the pavement slab assembly 1.

1. A housing for at least one object detection device of a system for inductive power transfer to a vehicle, wherein the housing comprises at least a top element and at least one bottom element, wherein the top and the bottom element are made of a non-metallic material, wherein the housing comprises at least one part of the at least one object detection device, wherein at least a part of the at least one object detection device is arranged in between the bottom and the top element, wherein the at least one object detection device is designed as an inductive detection device, and
wherein
the inductive detection device comprises at least one excitation element.

2. The housing according to claim 1, wherein the top element is designed as a plate or the bottom element is designed as a plate.

3. The housing according to claim 1, wherein the top element or the bottom element is made of plastic.

4. The housing according to claim 1, wherein a height of the top element is less than a height of the bottom element.

5. The housing according to claim 1, wherein a height of the top element is equal to a height of the bottom element.

6. The housing according to claim 1, wherein the housing provides an inner volume for arranging a first part of the at least one object detection device and at least another part of the at least one object detection device.

7. The housing according to claim 1, wherein the housing provides a first inner volume for arranging a first part of the at least one object detection device and at least one other inner volume for arranging at least another part of the at least one object detection device.

8. The housing according to claim 7, wherein the bottom element is arranged between the first and the at least one other inner volume.

9. A primary unit of a system for inductive power transfer, wherein the primary unit comprises at least one primary winding structure and at least one object detection device,
wherein
primary unit comprises a housing according to claim 1.

10. The primary unit according to claim 9, wherein a first inner volume of the housing is arranged above the primary winding structure.

11. The primary unit according to claim 9, wherein the top element provides an upper outer surface of the primary unit.

12. A pavement slab assembly for a route for vehicles driving on a surface of the route, wherein the pavement slab assembly comprises a housing according to claim 1.

13. The pavement slab assembly according to claim 12, wherein the top element or the bottom element is made of pavement material.

14. The pavement slab assembly according to claim 12, wherein the top element provides at least a part of an upper outer surface of the pavement slab assembly.

15. The pavement slab assembly according to claim 12, wherein the pavement slab assembly further comprises a non-metallic positioning element, wherein the housing and the positioning element are arranged such that the housing is positioned at a predetermined position within the pavement slab assembly.
